(19) United States
(12) Patent Application Publication
(10) Pub. No.: US 2009/0176446 A1
(43) Pub. Date: Jul. 9, 2009

(54) ROLLING MEAT TENDERIZER

(76) Inventor: John Brubaker, Camp Hill, PA (US)

Correspondence Address: FELDMANGALE, P.A., 1700 Market Street, Suite # 3130, Philadelphia, PA, 19103, US

(21) Appl. No.: 11/971,583

(22) Filed: Jan. 9, 2008

(51) Int. Cl. A22C 9/00

(52) U.S. Cl. 452/141

(57) ABSTRACT

A machine for tenderizing meat. Said machine includes a textured roller and a smooth plate between which untenderized meat is fed for tenderizing. Pressure is applied to the untenderized meat as it passes between the roller and plate thereby tenderizing and flattening the meat to the desired thickness and texture.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention lies in the field of food preparation products. In particular, it relates to the processing and tenderizing of meat products.

### BACKGROUND OF THE INVENTION

One of the many tasks in the preparation of meat products includes pounding for the purpose of flattening and tenderizing the meat. This process can be applied to conch, chicken, pork, veal, and beef, for example. Such flattening and tenderizing is needed to make such dishes as cracked conch, chicken parmesan, veal scaloppini, and beef cutlets.

The physical act of pounding the meat breaks down the meat's tough fibers. While such tenderizing can be achieved by chemical measures, i.e., using an acid to break down the fibers, such as by marinating, chefs prefer to use the physical tenderizing because the time needed for marinating is significantly greater than pounding. By pounding meat, chefs are further able to control the thickness or width of the meat which is essential for certain recipes or preparations.

There are two kinds of tools available to perform the pounding task: a meat or tenderizing mallet and a meat tenderizing machine. The mallet tends to work the best, but has drawbacks. For example, the noise level produced from the force of hammering the meat on to whatever surface is used is undesirably loud. Second, physical pounding requires a significant amount of time because every piece of meat must be pounded individually. Also, the manual process makes the meat consistency vary, which leads to uneven cooking. Moreover, hammering can frequently produce tears and holes in the meat, rendering it unusable and, therefore, wasting the product. Finally, physical hammering tires the chef because of the force needed to hammer the meat and the volume of product to be processed puts a physical strain on the individual's hands and arms. Accordingly, the tenderizing process is slowed down the more the user needs to use the mallet.

Prior art meat tenderizing machines runs the meat product between blades to perform the tenderizing. Such machines also have drawbacks. First, the machine operates at a fixed setting. Thus, it only prepares product having a single thickness. Second, because blades are used to perform the tenderizing, they only slice or score the meat. Because such machines do not flatten the product, a flattening method or technique must still be used after slicing the meat. After two or three passes through these blades, the meat starts to shred. Finally, sanitation is an issue because the rollers are fixed and cannot be removed easily. Thus, it becomes very difficult to clean the machine, leading to undesired cross-contamination.

### SUMMARY OF THE INVENTION

The present invention provides a tool that achieves the task of pounding flattening and tenderizing faster and more efficiently, consistently, and sanitarily.

As set forth herein, the word “tenderizing” shall mean processing the meat in any way to make it softer and flatter than before and can include pounding, crushing, tearing, flattening, macerating, banging or any other physical process that accomplishes these goals.

### BRIEF DESCRIPTION OF THE DRAWINGS

Advantages of embodiments the present invention will be apparent from the following detailed description of the preferred embodiments thereof, which description should be considered in conjunction with the accompanying drawings in which:

FIG. 1 is a left elevated view of a meat tenderizing machine according to the invention;

FIG. 2 is a right elevated exploded view of a meat tenderizing roller of the machine of FIG. 1;

FIG. 3 is an exploded view of the roller of FIG. 1;

FIG. 4 is a front-on view of the roller of FIG. 1;

FIG. 5 is a right side elevational view of the machine of FIG. 1; and

FIG. 6 is a radial, cross-sectional left view of the machine in FIG. 1.

### DETAILED DESCRIPTION OF THE PREFERRED EMBODIMENTS

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention.

While the specification concludes with claims defining the features of the invention that are regarded as novel, it is believed that the invention will be better understood from a consideration of the following description in conjunction with the drawing figures, in which like reference numerals are carried forward.

Before the present invention is disclosed and described, it is to be understood that the terminology used herein is for the purpose of describing particular embodiments only and is not intended to be limiting. It must be noted that, as used in the specification and the appended claims, the singular forms “a,” “an,” and “the” include plural references unless the context clearly dictates otherwise.

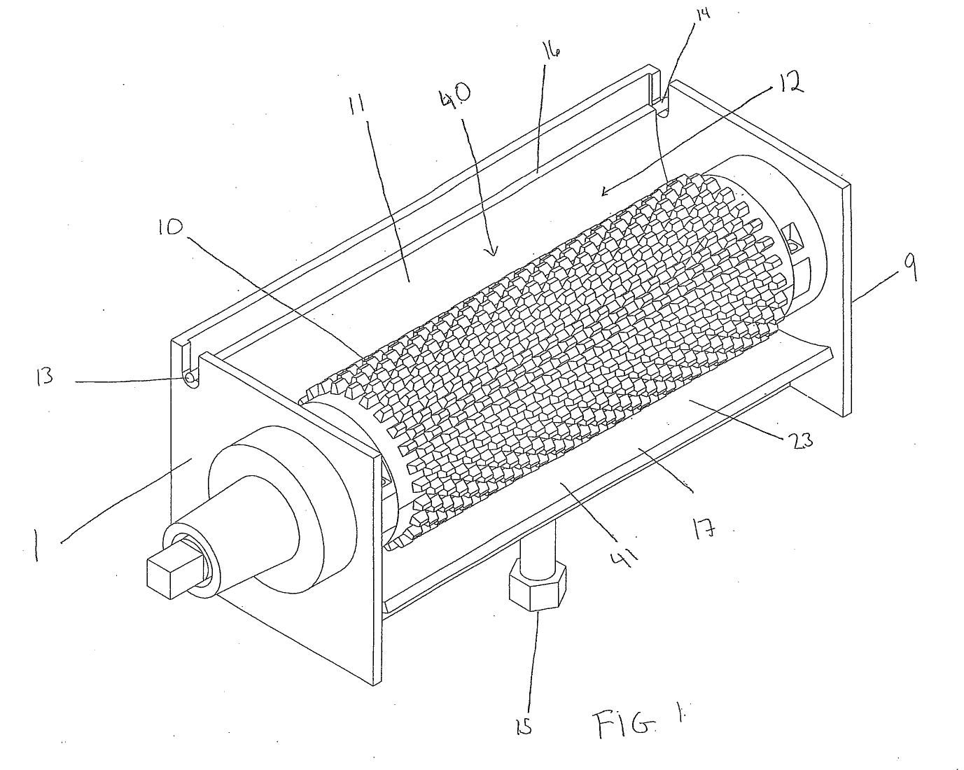

FIG. 1 is a left elevated view of an embodiment of the machine 1 according to the invention. This embodiment provides a frame 9, a first meat-contacting device 10 which is a roller, and an opposing second meat-contacting device 11 which, in this embodiment, is a curved plate having a smooth interior surface 12. In other embodiments, a flat plate could be used consistent with the invention disclosed herein.

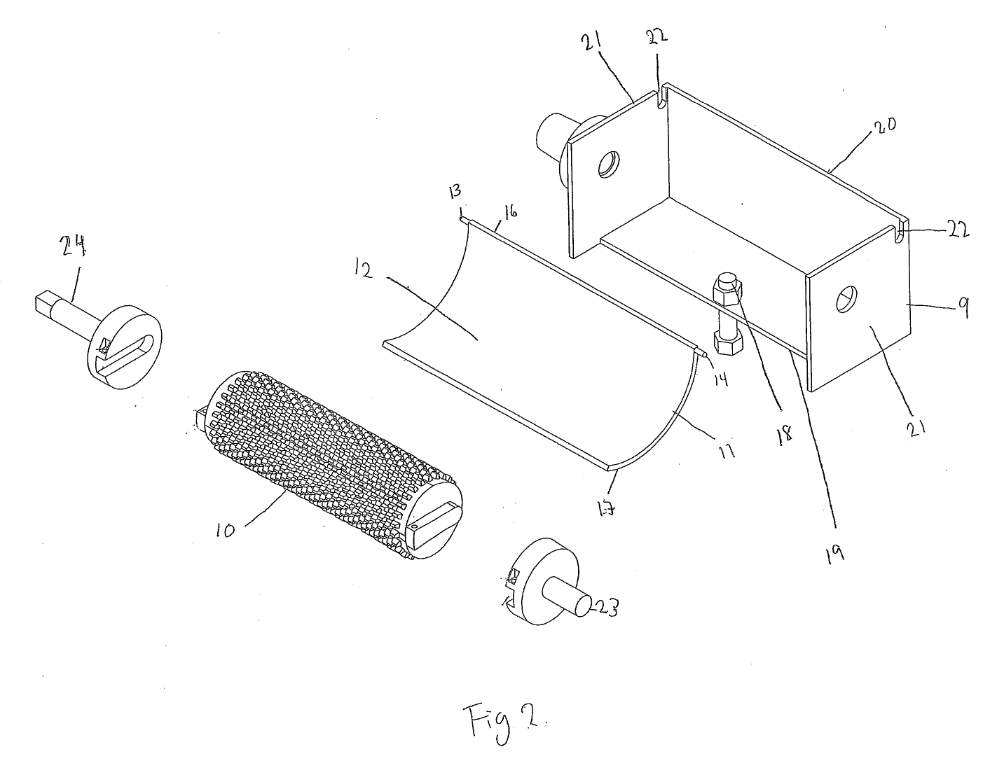

The curved plate 11 has pivotal connections 13, 14 at either end of the leading edge 16 and an adjustable connection 15 at the trailing edge 17 of the other end. In other embodiments, the meat-contacting device 11 may be substantially planar without any curvature. These connections 13, 14 are shown at the leading edge of the curved plate 16 and the connection 15 is shown at the trailing edge of the curved plate 17. The positions, however, can be reversed. The pivotal connections 13, 14 can be formed from a hinge, for example, a piano hinge. The adjustable connection 15 can be any device that provides a pivot stop 18 (FIG. 2) against the rear surface of the plate, 11, but also is adjustable. In particular, a set screw 15 can be threaded through the frame 9 to contact the rear surface of the curved plate 11. As the screw 15 is threaded inward, the plate 12 moves closer to the opposing roller 10. The roller 10 has a texture that may be formed by trapezoidal teeth applied around cylinder. In such a configuration, the teeth, which may be more or less evenly spaced, applies the function of a meat mallet because it continuously applies the same pattern and pressure needed to break but not cut the fibers of the meat and thereby tenderize the meat. The shape of the teeth should not be considered a limitation hereto and may be pyramidal, diamond shaped, rectangular, square or any other shape suitable for texturizing meat. Furthermore the height of the teeth should not be considered as a limitation. The only requirement is that the teeth be elevated enough to allow for the texturization of the meat during processing without tearing.

The frame 9 is, preferably, of stainless steel with a stainless sleeve at one end to fit into a motor opening. FIG. 2 is an exploded view of an exemplary embodiment of the machine, 1. The base, 19, has a threaded bore for receiving the set screw, 18, therein. The back, 20, connects to the base, 19, in a plane orthogonal to the plane of the base 71. Each of the sides 21 connect to both the base 19 and the back 20 in a third plane orthogonal to both the planes of the base 19 and the back 20. Each side 21 has a gap 22 for pivotally receiving the plate 11 therein. It should be appreciated that the shape of the frame is not a limitation as a frame according to the instant invention could be formed in different shapes. Furthermore, while in one embodiment, the frame includes a base, in other configurations, the base may be omitted. In those instances other mechanisms such as projections for adjusting the width between the gap and the plate would be included on the sides of the frame.

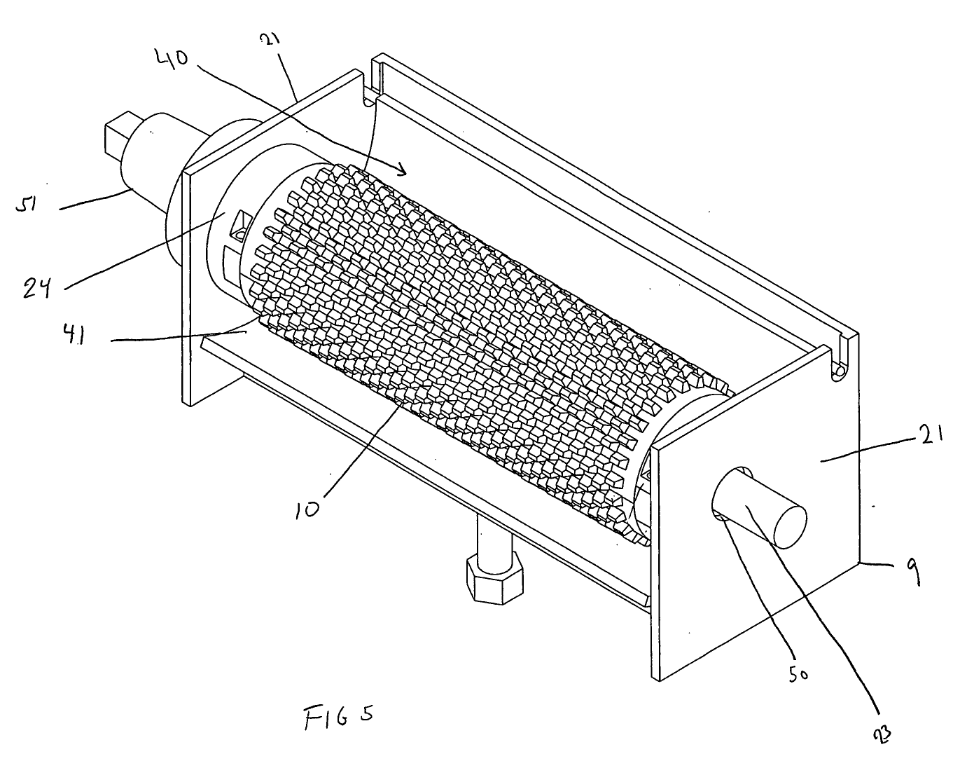

The curved surface 12 of the plate 11 in conjunction with the roller 10 applies enough pressure to help catch the meat as it is passed into the machine 1 through the upper gap 40 between the roller and plate and pass it through the lower gap 41 without the meat getting stuck therein and destroyed. (FIG. 5).

The preferred material of the rollers 10, 20 is aluminum. Thus, the rollers 10, 20 will be relatively strong and relatively light. Most importantly, however, is that aluminum does not rust. Accordingly, the meat 60 being processed is protected from becoming soiled and unsanitary. It should be appreciated by one skilled in the art that the roller 10 and the frame 9, however, may be composed of a variety of different materials such as stainless steel, aluminum, plastics, polyvinyl chloride, wood, or any other suitable material without departing from the instant invention. Furthermore, it should be appreciated that the frame 9, roller 10 and plate 11 may be coated with a substance such as teflon or other similar coating to further improve the performance or characteristics of the tenderizer according to this invention.

FIG. 1 further shows a preferred embodiment of the texture 43 of the teeth that may be used to texture the meat. As can be seen, each tooth 42 is more or less trapezoidal. The teeth may further be more or less evenly spaced.

With a motor attached to the roller 10, for example, the machine 1 will provide an automated rolling mallet accomplishing the tasks of tenderizing and flattening the meat simultaneously without the use of a physical hammering force and the corresponding byproduct of noise associated with such manual pounding.

FIG. 2 shows an exploded view of a three-piece embodiment of the roller 10, current plate 11 connecting axles 23, 24 and the frame 9 according to this invention.

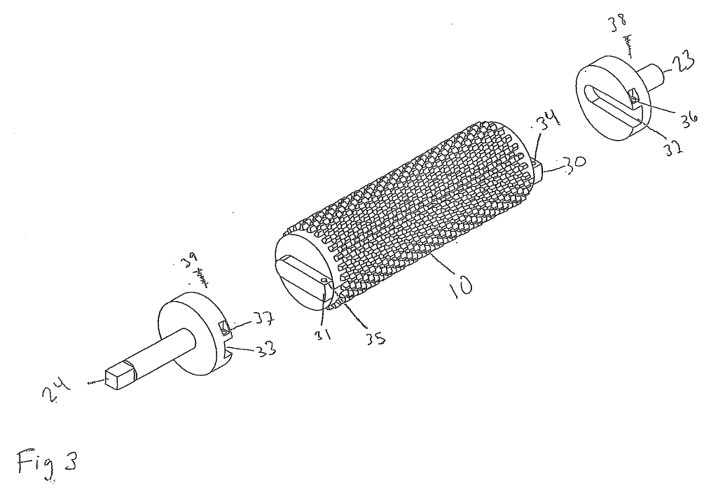

FIG. 3 is another view of this embodiment of the invention and depicts how the roller 10 can be connected to the frame 9. Each end of the roller has a tongue 30, 31 projecting therefrom. The tongues 30, 31 can be removably connected to the roller 10 but, preferably, they are integrally attached. Each tongue 30, 31 reflects two features. First, it has an outer shape that is configured to fit inside a respective groove 32, 33 of each of the axles 23, 24. The shape is selected such that rotation of the axle 23, 24 will cause a corresponding rotation of the roller 10. Second, each tongue 30, 31 has a dimple 34, 35.

FIG. 3 further shows corresponding dimples 36, 37 in each of the axles 23, 24. The configuration of pinholes permits a respective removable set screw to be inserted through each of the pinholes 36, 37 and, thereby, removably connect each axle 23, 24 to the roller 10. Preferably, the dimples 34, 35, 36 and 37 each have an internal thread, which receives a correspondingly threaded pin 38, 39 as shown in the illustrations of the axles 23, 24.

To further illustrate the connection between the roller 10 and the axles 23, 24 further reference is made to FIG. 3. FIG. 3 shows how the roller 10 can be disassembled from the roller axle 23 (on the right of these figures) and the power axle 24 (on the left of these figures). Simple unscrewing of the pins 38, 39 allows the roller to disengage from the axles 23, 24. Then, when the roller 10 is removed, the two axles 23, 24 can be removed from the right and left sides 21 of the frame 9.

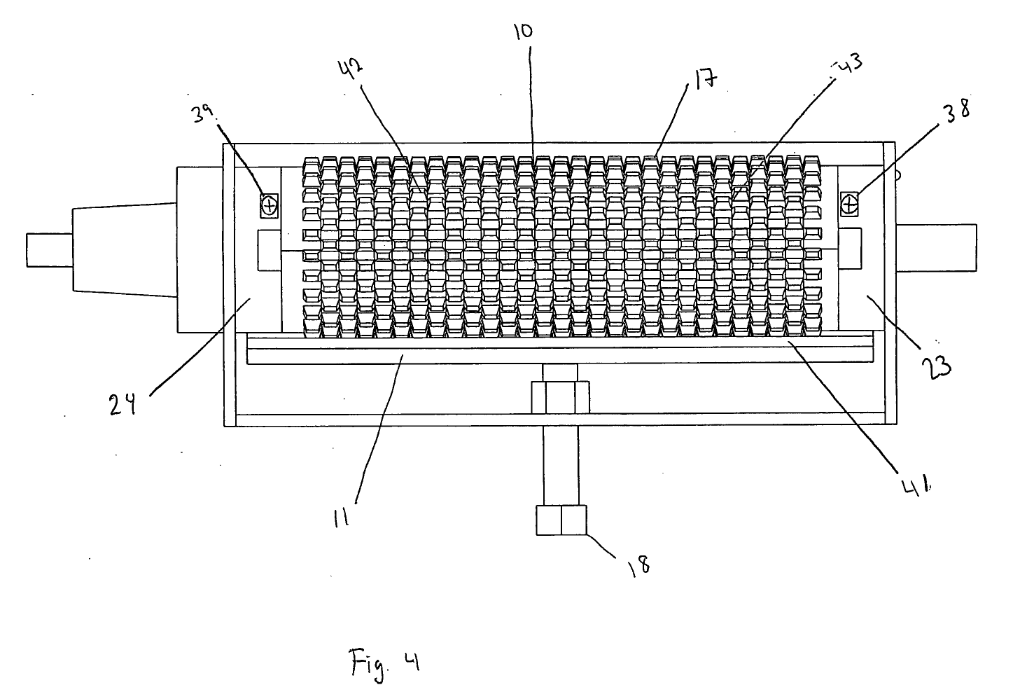

FIG. 4 shows the roller 10 assembled with each axle 23, 24 held in place by set screws 38, 39. As further shown in FIG. 4, the screw adjustment allows an altering in the width of the gap 41 between the curved plate 11 and the roller 10. By varying the width of the gap, the instant invention allows thick pieces of meat 60 to pass through first and, then, to allow the meat 60 to gradually get thinner as subsequent passes are made, each pass using successively thinner gaps 41 by adjusting the set screw 18. It should be readily appreciated by those of reasonable skill in the art that other mechanisms allowing the adjustment of the width between gap and plate may be used. By way of example but not limitation other methods include mounting ledges mounted on the side of the device walls, fixed pins allowing the plate to rest at various elevations or any other mechanism whereby the width of the gap between the roller and plate may be adjusted and maintained during processing.

As shown in FIG. 5, to allow the roller 10 to spin with the axles 23, 24 the right side 21 of the frame 9 housing the roller axle 23 is constructed with an aperture 50 shaped to receive the roller axle 23 therein. The left side 21 of the frame, in comparison, is constructed with a bearing 51 that slidably receives the power axle 24 therein. The power axle 24 extends beyond the end of the bearing 51 opposite the roller 10 so that a roller powering device, such as a hand crank or a motor, can be connected to the power axle 24. In such a configuration, when the powering device is caused to turn the power axle 24, the roller 10 and both axles 23, 24 spin within the frame 9. It should be readily appreciated that the power axle may also be constructed so as to allow the roller to be rotated by means of a device such as a Kitchen Aid household mixer, hand crank, gear mechanism, or other mechanical motor. Depending on the size of the motor's drive, the use of adapters may be employed or power axles of different dimensions may be used.

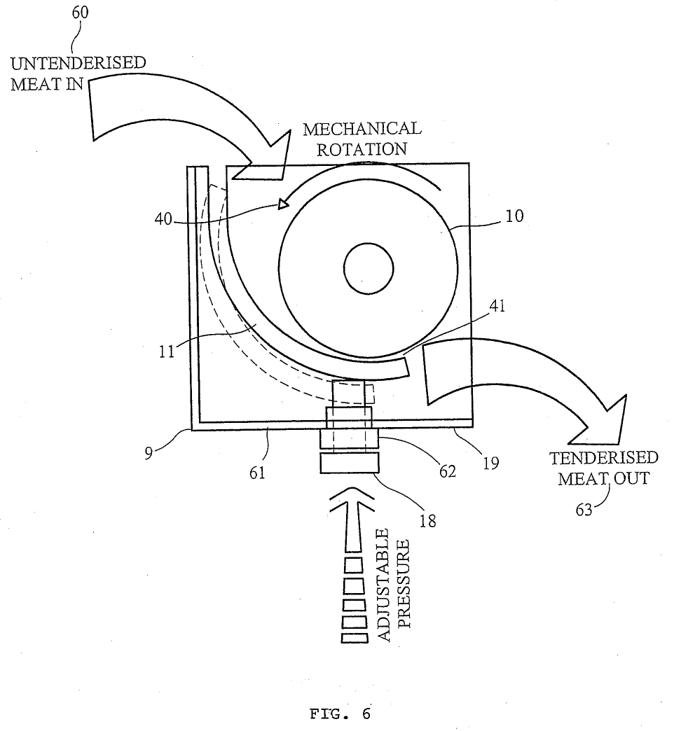

As shown in FIG. 6, the meat for tenderizing 60 is inserted into the gap 40 between the roller 10 and the curved plate 11. The tenderized meat 63 exits the machine through the gap 41 between the trailing edge of the curved plate 17 and the roller 10. An exemplary embodiment of the plate 11 is shown in FIG. 2 The plate 11 is pivotally connected to the frame 9 at each gap 22 on the two sides 21 in a first connection 13, 14 which is in the form of a rod extending from the sides of the plate 11. Thus, the plate 11 can move in an arc with respect to the frame 9 between an upper-most position touching the roller 10 and a lower-most position touching the base 19 of the frame 9. The plate 11 can be adjusted anywhere between these two positions by providing a second connection 61, which, in a preferred embodiment, is formed by a threaded hole 62 and a setscrew 18. Accordingly, movement of the setscrew 18 into the hole 62 lifts the plate 11 away from the base 19 and towards the roller 10.

As further shown in FIG. 6, in the tenderizing process, the meat 60 enters the top gap 40 and exits the bottom gap 41. The texture 17 breaks the fibers of the meat 60 as it rotates between the roller, 10, and the curved plate, 11. The curved plate, 11 offers a surface for the meat to expand (i.e., flatten) while the meat 60 rotates inwards and downwards without being torn apart. The flat surface, 12, and the texture, 17, together, provide enough pressure and force to tenderize any meat 60 without tearing it. The meat, 63, which has passed through the machine, 1, can be used immediately or the passed through the roller, 10, and curved plate, 11, again for a thinner or more tenderized resulting piece of meat. Because the surface, 12, of the curved plate, 11, allows the meat 60 to expand, the meat 60 can be pass through the roller, 10, and curved plate, 11, as many times as required for the particular use.

FIG. 4 depicts a face on view. By adjusting the set screw 18, the diameter of the gap 41 may be varied. This in turn allows the machine to produce tenderized meat 63 of varying degrees of thickness.

I claim:

1. A meat tenderizer comprising a frame, a roller, and a plate, said roller further comprising teeth; said roller being detachably attached to a means for providing rotation of the roller; and said plate and said roller being separated by a gap of a distance appropriate to tenderize meat.

2. A meat tenderizer as claimed in claim 1 said plate further being curved.

3. A meat tenderizer as claimed in claim 1 said plate further being capable of adjustment thereby varying the distance between said roller and said plate.

4. A meat tenderizer as claimed in claim 2 said curved plate further being capable of adjustment thereby varying the distance between said roller and said plate.

5. A meat tenderizer as claimed in claim 4 said frame comprising sides, a back and a base.
